(19) United States
(12) Patent Application Publication
(10) Pub. No.: US 2025/0020815 A1
(43) Pub. Date: Jan. 16, 2025

(54) SCINTILLATION COMPOSITIONS AND RELATED HYDROGELS FOR NEUTRON AND GAMMA RADIATION DETECTION, AND RELATED DETECTION SYSTEMS AND METHODS

(71) Applicant: Battelle Energy Alliance, LLC, Idaho Falls, ID (US)

(72) Inventors: Catherine L. Riddle, Idaho Falls, ID (US); Dawn M. Scates, Idaho Falls, ID (US); Ryan G. Fronk, Idaho Falls, ID (US); Rick L. Demmer, Idaho Falls `, ID (US); Priyarshini Ghosh, Manhattan, KS (US)

(21) Appl. No.: 18/422,242

(22) Filed: Jan. 25, 2024

Related U.S. Application Data
(60) Provisional application No. 63/481,514, filed on Jan. 25, 2023.

(51) Int. Cl. G01T 1/204; B82Y 15/00; B82Y 20/00; B82Y 40/00; C09K 11/88; G01T 1/208; G01T 3/06

(52) U.S. Cl. CPC G01T 1/2042; C09K 11/883; G01T 1/208; G01T 3/06; B82Y 15/00; B82Y 20/00; B82Y 40/00

(57) ABSTRACT

Scintillation compositions comprising one or more different types of quantum dots dispersed in a polymer matrix material, the quantum dots having a core-shell structure, and optionally a neutron-capturing isotope. Hydrogels comprising the quantum dots and optional neutron-capturing isotope in a polymerized matrix are also disclosed, as are related detection systems and methods.

### CROSS-REFERENCE TO RELATED APPLICATION

This application claims the benefit under 35 U.S.C. § 119(e) of U.S. Provisional Patent Application Ser. No. 63/481,514, filed Jan. 25, 2023, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure, in various embodiments, relates generally to radiation detection. More specifically, the disclosure, in various embodiments, relates to scintillation compositions and hydrogels formed from the scintillation compositions for the detection of neutron and/or gamma radiation, and to related methods and detection systems.

### BACKGROUND

There is a significant need for large area, radiation characterization, scintillator materials. While radioactive materials that enter the U.S. can be detected, it is often not possible to characterize the radiation signature of that material (identify the radionuclides) nor tell if more than one radiation source is present. The ability to validate radioactive “hits” from items that trip the portal monitoring system would be a great improvement for national security. It is not only important to detect the presence of radiation, but to be able to characterize which specific energy, and thus which radionuclides, are present. Scintillator detectors are used for that task. Importantly, scintillator materials can discriminate the difference between radionuclides, guiding investigators to determine if multiple radionuclides are present, if those isotopes may be nefarious, and if all are properly manifested.

Characterization of radioactive materials at ports around the country is hampered by the small size of conventional scintillation systems. The problem is that scintillation materials, typically crystals, are usually of small size and are expensive and fragile. A scintillation detector is typically composed of a fluorescent scintillator material (a “fluor”) coupled with a light detector system (usually a photomultiplier tube) such that radiation striking the fluor is converted into a light pulse to be quantified. These light pulses are then used to determine the energy and quantity of the radiation impinging on the scintillation material. The fluor may be a cylindrical crystal of sodium iodide (NaI) (doped with a metal such as thallium) or a more complex system.

Conventional scintillation materials are expensive, laboratory grown crystals, produced in small sizes (typically about 100 cm³). These crystals are then machined to their intended size, typically about 76 mm. The NaI scintillation crystal would need to be on the order of 4000 cm³ to be effective for use in large port units. These size crystals are very expensive and each portal monitor may use an array of eight of these large, expensive detectors.

Moreover, for neutron detection, the growing shortage and increasing expense of helium-3 (He-3 or ³He), which is a light, non-radioactive isotope of helium and the most important isotope in instrumentation for neutron detection, is problematic. He-3 is used in conventional neutron detectors because it has a large capture cross-section for neutrons. When a neutron meets a He-3 atom, they react to form tritium (H-3), which is an isotope of hydrogen with one proton, one electron, and two neutrons, and a hydrogen atom (1H, one proton and one electron), giving off energy in the process.

The U.S. Department of Homeland Security ensures the safety of the borders and ports against import of special nuclear material (SNM), such as highly enriched uranium and plutonium. Neutron detection has become increasingly difficult because of the worldwide shortage of He-3 due to the nuclear arsenal drawdown at the end of the Cold War. In addition, neutron detection is difficult due to high levels of background noise, high detection rates, and the neutral charge and low neutron energy of the neutrons.

### BRIEF SUMMARY

A scintillation composition is disclosed. The scintillation composition comprises one or more different types of quantum dots dispersed in a polymer matrix material, the quantum dots comprising a core-shell structure.

Also disclosed is a hydrogel. The hydrogel comprises a polymerized matrix material and one or more different types of quantum dots in the polymer matrix material.

Also disclosed is a detection system. The detection system comprises an enclosure, at least one photomultiplier tube in the enclosure, and a hydrogel in proximity to the at least one photomultiplier tube. The hydrogel of the detection system is configured to detect at least one of neutron radiation or gamma radiation. The hydrogel comprises one or more different types of quantum dots and a polymerized matrix material.

Also disclosed is a method of detecting radiation emitting from an article. The method comprises positioning an article emitting one or more of neutron radiation and gamma radiation proximal to a hydrogel of a detection system and detecting the one or more of the neutron radiation and gamma radiation. The hydrogel comprises a polymerized material comprising one or more different types of quantum dots and an optional neutron-capturing isotope.

### BRIEF DESCRIPTION OF THE DRAWINGS

FIG. 1 is a schematic of a core-shell quantum dot (e.g., an indium phosphide/zinc sulfide (InP/ZnS) core-shell nanoparticle) according to embodiments of the disclosure.

FIG. 2 is a line drawing of scintillation hydrogels according to embodiments of the disclosure.

FIG. 3 is a schematic drawing of a photomultiplier tube (PMT) detection system including a hydrogel according to embodiments of the disclosure and configured to detect at least one of neutrons or gamma rays.

FIG. 4 is a schematic drawing of a detection system including a hydrogel according to embodiments of the disclosure and configured to detect at least one of neutrons or gamma rays.

FIG. 5 is a schematic drawing of an alternate detection system including a hydrogel according to embodiments of the disclosure and configured to detect at least one of neutrons or gamma rays.

FIG. 6 is a schematic drawing of a quantum dot (QD) nanoparticle functioning within a scintillation hydrogel including ⁶Li and illustrating radiation interacting within the QD in the scintillation hydrogel produces highly ionizing secondary radiation that excites the quantum dot material, producing a pulse of light, in accordance with embodiments of the disclosure.

FIG. 7 is a graph showing 48-hour and 10-min measurements (counts, y-axis, versus channel, x-axis) of the empty hydrogel spectra without any sources present.

FIG. 8 is a graph showing count rate (y-axis) versus channel (x-axis) upon irradiation of the scintillation hydrogel with ²⁵²Cf.

FIG. 9 is a graph showing count rate (y-axis) versus channel (x-axis) indicating the detection of neutrons by the scintillation hydrogel using a ²⁵²Cf neutron source.

FIG. 10 is a graph showing pulse height (V) versus time (x-axis, microseconds) of the irradiation of the scintillation hydrogel with ²⁵²Cf.

FIG. 11 is a graph showing pulse height (V) versus time (x-axis, nanoseconds (ns)) where waveforms upon irradiating the photomultiplier tube (PMT) with ²⁵²Cf had only one exponential decay time of 20 ns.

FIG. 12 is a graph showing absorbance (AU, y-axis) versus wavelength (nanometers, x-axis) for a hydrogel comprising indium-phosphide/zinc sulfide quantum dots in accordance with embodiments of the disclosure.

### DETAILED DESCRIPTION

Scintillation compositions for neutron and/or gamma radiation detection, hydrogels produced from the scintillation compositions, and related detection systems that include the hydrogels are disclosed. Methods of detecting neutrons and/or gamma radiation are also disclosed. The hydrogels produced from the scintillation compositions may be used to detect, e.g., plutonium-239 (²³⁹Pu), uranium-233 (²³³U), or uranium-235 (²³⁵U), which emit neutrons and gamma radiation. The scintillation compositions and hydrogels of embodiments of the disclosure may exhibit one or more of low cost, high performance, simple and quick to manufacture, and environmentally friendly for deployment both domestically and around the world. The scintillation compositions and hydrogels may also have higher spatial resolution (crisper images), may have higher energy resolution for scatter rejection, may be brighter as far as light yield, and may have much lower afterglow of light, enabling accurate monitoring of exact quantity and type of nuclear materials, which may reduce the amount of false positive or negative results which may result in facility and verification delays. There is an urgent need for new neutron detection technologies that have equivalent or higher efficiencies than He-3 in order to replace aging neutron detectors and develop new radiation monitors. The scintillation compositions may be used as a direct replacement, with minimal retrofit, for scintillators in He-3 neutron detectors and for scintillators for gamma radiation detection. Use of the scintillation compositions and hydrogels of the disclosure may enable widespread protection against the importing of nuclear material and weapons.

As used herein, the term “scintillation composition” means and includes a composition formulated to detect neutron and/or gamma radiation and refers to the components before a polymerization process is conducted. The scintillation composition includes one or more scintillation components and a polymer matrix material. Depending on the radiation (e.g., neutron or gamma radiation) to be detected, the scintillation composition may include additional components, e.g., a neutron-capturing isotope.

As used herein, the term “hydrogel” means and includes a three-dimensional network of polymer chains formed by polymerization of the polymer matrix material of the scintillation composition and having the one or more scintillation components and optional neutron-capturing isotope homogeneously dispersed therein. The three-dimensional network of polymer chains is hydrophilic and capable of holding water. The hydrogel may be an organic gel, an inorganic gel, or a hybrid of an organic/inorganic gel depending on the scintillation component(s) and polymer matrix material that is used.

The hydrogel produced from the scintillation composition may be optically transparent and stable. As used herein, the terms “transparent” and “transparency” refer to the transmittance per unit path length in a material of light, e.g., scintillation light. For instance, a material transparent to scintillation light transmits, per meter of material, at least about 90%, generally about 95%, and more typically about 98% of scintillation. Typically, the scintillation transmitted is in a range from about 400 nanometers (nm) to about 600 nm, generally from about 350 nm to about 600 nm, or more typically from about 300 to about 600 nm. Thus, in some aspects, transparent materials transmit about 95% of scintillation between about 350 nm and about 600 nm, or more typically, transmit about 98% of scintillation between about 300 nm and about 600 nm.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should, or must be, excluded.

The scintillation composition may comprise one or more scintillation components (e.g., quantum dots) and a polymer matrix material. In embodiments, the scintillation composition comprises one type or a combination of different types of quantum dots dispersed in a polymer matrix material. In embodiments, the quantum dots comprise a core-shell structure. In embodiments, a hydrogel comprises a polymerized matrix material having quantum dots dispersed in the hydrogel, the hydrogel optionally including LiCl.

Neutron flux is a measure of the intensity of neutron radiation, determined by the rate of flow of neutrons. The neutron flux value is calculated as the neutron density (n) multiplied by neutron velocity (v), where n is the number of neutrons per cubic centimeter (expressed as neutrons/cm³) and v is the distance the neutrons travel in 1 second (expressed in centimeters per second, or cm/sec). Consequently, neutron flux (nv) is measured in neutrons/cm²/sec. In embodiments of the disclosure, different reactive materials are selected to tailor the scintillation composition for sensitivity to gamma-ray or fast- or thermal-neutron local flux. The one or more scintillation components and any additional components may be homogeneously dispersed in the polymer matrix material. The scintillation composition may be formulated to produce a hydrogel upon polymerization of the polymer matrix material, with the one or more scintillation components and optional additional components homogeneously dispersed throughout the hydrogel. The components of the scintillation composition may be selected to produce an optically transparent and stable hydrogel. By forming the scintillation composition into a hydrogel, the scintillation composition may exhibit properties of both liquid and solid (e.g., crystalline, plastic) scintillators without many of the disadvantages associated with these scintillators.

The scintillation component of the scintillation composition may be selected depending on the radiation to be detected. The scintillation component may be one or more quantum dots. Optionally, the scintillation component may further include one or more of thallium doped cesium iodide, thallium doped sodium iodide, or cerium doped lutetium iodide, each of which is useful in the detection of gamma radiation. To enhance the performance of the scintillation component, particular aspects of the disclosure provide for the use of one type (i.e., one chemical composition, material composition) or a combination of different types of quantum dots (QD), i.e., quantum dots composed of different chemical compositions. “Quantum dots,” “nanoparticles” or “nanocrystals,” are used interchangeably herein to refer to nanometer sized semiconductor particles that have optical properties arising from quantum confinement. Quantum dots may have various shapes, including, but not limited to, a sphere, a rod, a disk, other shapes, and mixtures of various shaped particles. The particular composition(s), structure, and/or size of a quantum dot may be selected to achieve the desired wavelength of light to be emitted from the quantum dot upon stimulation with a particular excitation source. In essence, quantum dots may be tuned (e.g., tailored) to emit light across the visible spectrum by changing their composition and/or size. In addition to being tunable, the quantum dots may exhibit a higher light yield than micron sized particles due to the increased surface area. As a scintillation component, quantum dots may be homogeneously dispersed or suspended throughout the hydrogel and may be selected to emit a particular wavelength of light for optimal scintillation within the scintillation composition. In particular, emission from a quantum dot capable of emitting light may be a narrow Gaussian emission band that may be tuned through the complete wavelength range of the ultraviolet, visible, or infra-red regions of the spectrum by varying the size of the quantum dot, the composition of the quantum dot, or both. For example, core-shell quantum dots may emit red (e.g., cadmium selenium/cadmium zinc sulfide (CdSe/CdZnS)), green (e.g., cadmium zinc selenium/cadmium zinc sulfide (CdZnSe/CdZnS)), or blue (e.g., cadmium sulfide/cadmium zinc sulfide (CdS/CdZnS)) light. The narrow size distribution of a population of quantum dots capable of emitting light may result in emission of light in a narrow spectral range. Since the quantum dots are tunable to a specific wavelength, the gamma and neutron radiation may be detected and quantified. Therefore, a radiation signature of a material containing one or more radionuclides may be characterized.

Quantum dots may be commercially available from NN Crystal Corporation, Thermo Fisher Scientific, Sigma-Aldrich, or other sources. Quantum dots may also be prepared by colloidal synthesis or plasma synthesis. For example, quantum dots may be prepared by heating a precursor material solution to form a core, and optionally adding additional material, which may the same or different than the core material, to form a shell. The quantum dot volume and size may be determined by selection of the concentration of core and shell monomers/materials in solution and by controlling the temperature.

The quantum dots according to embodiments of the disclosure may be prepared by conventional methods and may be composed of materials including an element of Group IVB, VB, VIB, VIIB, VIIIB, IB, IIB, IVA, and/or VA of the Periodic Table of the Elements. In some aspects, the material is or includes a metal, a transition metal or post-transition metal. In other aspects, the transition metal is a metal selected from scandium, titanium, vanadium, chromium, magnesium, iron, nickel, copper, yttrium, zirconium, indium, gallium, tin, bismuth, technetium, ruthenium, molybdenum, rhodium, tungsten, gold, platinum, palladium, silver, manganese, cobalt, cadmium, hafnium, tantalum, rhenium, osmium, iridium, and mercury (Sc, Ti, V, Cr, Mg, Fe, Ni, Cu, Y, Zr, Nb, Zn, In, Ga, Sn, Bi, Tc, Ru, Mo, Rh, W, Au, Pt, Pd, Ag, Mn, Co, Cd, Hf, Ta, Re, Os, Ir and Hg, respectively).

Quantum dots may be prepared from a material selected from elements of Group I-VII, Group II-VI, Group III-V, Group IV-VI, Group III VI, Group I-VI, Group V-VI, Group II-V, Group I-III-VI₂, Group IV, ternary or quaternary semiconductors and alloys or combinations thereof. In some aspects, the material is a Group I-VII material, e.g., copper(I) fluoride (CuF), copper(I) chloride (CuCl), copper(I) bromide (CuBr), copper(I) iodide (CuI), silver(I) fluoride (AgF), silver(I) chloride (AgCl), silver(I) bromide (AgBr), silver(I) iodide (AgI), and the like. In other aspects, the material is a Group II-VI material, e.g., cadmium oxide (CdO), cadmium selenide (CdSe), cadmium sulfide (CdS), cadmium telluride (CdTe), cadmium zinc telluride (CdZnTe), mercury (II) oxide (HgO), mercury (II) sulfide (HgS), mercury selenide (HgSe), mercury telluride (HgTe), beryllium oxide (BeO), beryllium sulfide (BeS), beryllium selenide (BeSe), beryllium telluride (BeTe), magnesium oxide (MgO), magnesium sulfide (MgS), magnesium selenide (MgSe), magnesium telluride (MgTe), cadmium selenium telluride (CdSeTe), zinc oxide (ZnO), zinc selenide (ZnSe), zinc telluride (ZnTe), zinc sulfide (ZnS), zinc cadmium selenide (ZnCdSe), cadmium selenium zinc sulfide (CdSeZnS), zinc cadmium sulfide (ZnCdS), and any combination thereof. In further aspects, the material is a Group III-V material, e.g., indium arsenide (InAs), indium phosphide (InP), indium nitride (InN), gallium nitride (GaN), indium antimonide (InSb), indium arsenic phosphide (InAsP), indium gallium arsenide (InGaAs), gallium arsenide (GaAs), gallium phosphide (GaP), gallium antimonide (GaSb), aluminum isopropoxide (AIP), aluminum nitride (AlN), aluminum arsenide (AIAs), aluminum antimonide (AlSb), boron phosphide (BP), barium sulfide (BaS), boron antimonide (BSb), and any combination thereof. In yet other aspects, the material is a Group IV-VI material, e.g., lead selenide (PbSe), lead telluride (PbTe), lead sulfide (PbS), lead tin telluride (PbSnTe), thallium tin telluride (Tl₂SnTe₅), germanium(II) sulfide (GeS), germanium monoselenide (GeSe), tin(II) sulfide (SnS), tin selenide (SnSe), germanium telluride (GeTe), tin telluride (SnTe), lead(II) oxide (PbO), and any combination thereof. Suitable ternary materials include, e.g., copper indium sulfide (CuInS₂), copper indium selenide (CuInSe₂), copper indium telluride (CuInTe₂), silver indium sulfide (AgInS₂), silver indium selenide (AgInSe₂) or silver indium telluride (AgInTe₂), antimony sulfoiodide (SbSI), antimony(III) sulfobromide (SbSBr), antimony selenium iodide (SbSeI), antimony selenium bromide (SbSeBr), antimony tellerium iodide (SbTeI), bismuth sulfochloride (BiSCl), bismuth sulfobromide (BiSBr), bismuth selenium chloride (BiSeCl), bismuth selenium bromide (BiSeBr), bismuth selenium iodide (BiSeI). Exemplary quaternary materials include, e.g., copper indium gallium sulfide (CuInGaS), copper indium gallium selenide (CuInGaSe), copper indium gallium telluride (CuInGaTe), copper indium sulfide (CuInS₂), copper indium selenide (CuInSe₂), copper indium telluride (CuInTe₂), copper gallium sulfide (CuGaS₂), copper gallium selenide (CuGaSe₂), copper aluminum selenide (CuAlSe₂), copper gallium telluride (CuGaTe₂), copper aluminum telluride (CuAlTe₂), silver indium gallium sulfide (AgInGaS), silver indium gallium selenide (AgInGaSe), silver indium gallium telluride (AgInGaTe), silver indium sulfide (AgInS₂), silver indium selenide (AgInSe₂), silver indium telluride (AgInTe₂), silver gallium sulfide (AgGaS₂), silver gallium selenide (AgGaSe₂), silver aluminum selenide (AgAlSe₂), silver gallium telluride (AgGaTe₂), or silver aluminum telluride (AgAlTe₂). In embodiments, the quantum dots comprise an environmentally friendly composition, for example, a composition that is free of cadmium.

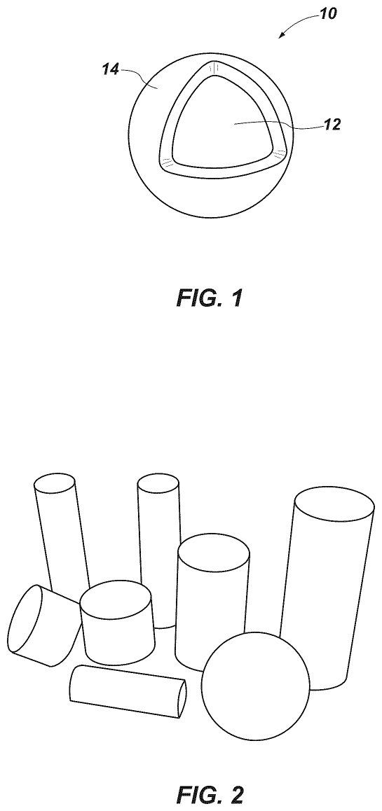

Turning to FIG. 1, the quantum dot 10 may include a core 12 having a shell 14 thereover. The quantum dots may comprise a combination of a narrow band gap semiconductor material and a wide band gap semiconductor material. Narrow band gap semiconductor materials may have a band gap of less than about 1.5 electron volts (eV), less than about 1.1 eV, or less than about 0.5 eV, and wide band gap semiconductor materials may have a band gap of greater than or equal to about 2 eV, although not limited. In embodiments, the quantum dot 10 has a core-shell architecture incorporating a semiconductor core 12 comprising the narrow band gap semiconductor material which is passivated by a shell 14 comprising the wide band gap semiconductor material, as shown in FIG. 1.

In some aspects, the quantum dots may have a core-shell architecture incorporating Group 12 ions (e.g., cadmium (Cd) and/or zinc (Zn)) and Group 16 ions (e.g., sulfur (S), selenium (Se) and/or tellerium (Te)). In accordance with this aspect, the quantum dot core-shell structure may have a semiconductor core, which is passivated by a shell of a wider band gap semiconductor such as zinc sulfide (ZnS), which may prevent self-absorption of light and may improve the light yield over conventional neutron detection materials. Turning again to FIG. 1, the quantum dot 10 may comprise an indium phosphide (InP) core 12 passivated by a shell 14 of ZnS. The indium phosphide core may comprise a cubic structure of indium and phosphorous. Indium phosphide may be prepared by any suitable method as known in the art. For example, indium phosphide may be prepared from the reaction of white phosphorus and indium iodide. Indium phosphide may also be prepared by the direct combination of indium and phosphorus at high temperature and pressure, or by thermal decomposition of a mixture of a trialkyl indium compound and phosphine. The core 12 may be passivated by any suitable method as known in the art. For example, the shell 14, such as a ZnS shell, may be coated over the InP core by contacting the indium phosphide core with a ZnS material at a temperature of from about 200 to about 250° C. to form a ZnS shell over the indium phosphide core. The shell may be a thin shell having a thickness of from about 1 nanometer (nm) to about 5 nm, or from about 10 nm to about 98 nm, wherein the thickness is the total diameter including the quantum dot core and shell.

In embodiments, the shell comprises ZnS and the core comprises InP. In further embodiments, the shell comprises ZnS having a band gap of from about 3.5 eV to about 3.9 eV and an InP core having a band gap of from about 1.34 eV to about 1.42 eV.

Alternatively, the scintillation component may include carbon quantum dots. The carbon quantum dots may be prepared by providing an electrochemical cell including an electrolyte comprising a carbon source, water, and at least another material. A current may be applied across electrodes of the electrochemical cell to form carbon quantum dots including carbon from the carbon source. The carbon quantum dots may be prepared from a carbon source optionally including at least one of (i.e., one or more of) nitrogen, boron, silicon, and phosphorus to form at least one of nitrogen-doped, boron-doped, silicon-doped, and phosphorus-doped carbon quantum dots, respectively. The carbon quantum dots may exhibit unique optical properties depending on a size and chemical composition (e.g., doping) of the carbon quantum dots, may be stable at wide pH ranges and temperatures (e.g., up to about 400° C.), and may be resistant to photobleaching and photo blinking.

The quantum dots according to the disclosure may have an average particle size in a range from about 1 nm to about 100 nanometers (nm), and preferably in a range from about 1 nm to about 99 nm. In other aspects, quantum dots may have an average particle size in a range from about 1 nm to about 50 nm (e.g., such as about 2, 5, 10, 15, 20, 25, 30, 35, 40, 45, or 50 nm). However, depending upon the composition, structure, and desired emission wavelength to be detected of the quantum dot, the average diameter may be outside of these ranges.

The scintillation component may be composed of one type or a combination of different types of quantum dots (e.g., 2, 3, 4, 5, 6, 7, 8, 9 types or more). By way of illustration, the scintillation component may be composed of indium phosphide/zinc sulfide (InP/ZnS) quantum dots or cadmium selenium/zinc (CdSe/Zn) quantum dots or may be composed of a combination of quantum dots such as two or more of InP/ZnS quantum dots, CdSe/Zn quantum dots, Cadmium Tellerium (CdTe), and Cadmium Zinc Tellerium (CdZnTe) depending on the application and radiation to be detected. The total amount of scintillation component in the scintillation composition may be between about 40 grams (g) per liter and about 80 g per liter of the scintillation component, or between about 50 g per liter and about 70 g per liter of the scintillation component. When using more than one type of quantum dot, the proportion of each type (e.g., material composition) of quantum dots in the scintillation component may be the same or different. A concentration of quantum dots in the scintillation composition may, at a minimum, be sufficient to produce a detectable amount of light when exposed to gamma radiation while the hydrogel remains optically transparent. The concentration of quantum dots in the scintillation composition may be maximized to produce the light of the specific wavelength provided that the hydrogel remains optically transparent, which varies depending on the quantum dot(s), matrix material, other material, employed. In other words, the concentration of the quantum dots in the scintillation composition may be less than the concentration that would result in the hydrogel not being optically transparent.

In aspects wherein the scintillation composition is for use in neutron detection, the scintillation composition may include a neutron-capturing isotope in combination with the scintillation component, which scintillates upon exposure of the neutron-capturing isotope to neutrons. The capturing isotope may be any neutron-capturing isotope known in the art, for example, ⁶Li, ¹⁰B, ¹¹³Cd, ¹⁵⁷Gd, and the like. In some embodiments, the neutron-capturing isotope is ⁶Li or ¹⁰B. In accordance with the disclosure, the capturing isotope may be provided in the form of an organic compound or an inorganic compound. The capturing isotope may exhibit a high neutron-capture cross section and may be in the form of a compound exhibiting a high solubility in polar and non-polar solvents, such as in water. In particular aspects, the capturing isotope may be a lithium compound. The increased solubility of lithium compounds may increase the amount (e.g., loading) of lithium in the resulting hydrogel, which may increase the neutron-capture ability of the hydrogel. For example, 84.25 g of lithium chloride may dissolve in 100 milliliters (mL) of water at 25° C., whereas lithium hydroxide has a 129 g/L solubility. The lithium compound may include, but is not limited to, lithium chloride (LiCl), lithium formate, lithium carbonate, lithium dithionate, lithium phosphate, lithium fluoride, lithium hydroxide, or combinations thereof. In some embodiments, the lithium compound is LiCl.

The compounds including neutron-capturing isotopes may be commercially available from numerous sources, such as Sigma Aldrich Chemical Co. (St. Louis, MO). The compound may be present in the scintillation composition at a loading of neutron-capturing isotope of from about 20% by volume to about 60% by volume. Likewise, the compound may account for about 20% by volume to about 60% by volume of the hydrogel produced from the scintillation composition. By way of example only, if the compound is LiCl, the LiCl may account for from about 40% to about 50% of the hydrogel produced from the scintillation composition. In comparison to conventional crystalline, liquid, or plastic scintillators, the increased maximum loading of the neutron-capturing isotope and the increased neutron-capture may enable the scintillation composition of the disclosure to exhibit a relatively larger neutron-capture cross section than conventional scintillators. Additionally, no fluorophore dye is required to achieve the high light yields created by LiCl for high detection efficiency that may match or exceed other neutron detectors.

The polymer matrix material of the scintillation composition for either gamma radiation detection or neutron detection may be water soluble such that water soluble components, such as the lithium compound, of the scintillation composition are absorbed. The polymer matrix material may be stable, non-toxic, and optically transparent when polymerized into the hydrogel. The polymer matrix material may be an organic or inorganic material including, but not limited to, an acrylamide, bis-acrylamide, N,N-methylene bisacrylamide, poly(N-vinylcarbazole), silicone, non-plasticizing silicone gel, two-part components of a polyurethane, or combinations thereof. Since the polymer matrix material is water soluble, the lithium compound and the scintillation component may be homogeneously dispersed or suspended in the polymer matrix material during formulation of the scintillation composition.

An amount of the polymer matrix material included in the scintillation composition may be selected to obtain the desired mechanical properties of the hydrogel, such as rigidity. By varying the concentration of the polymer (e.g., acrylamide, etc.) and water, a more spongy hydrogel or a more rigid hydrogel may be obtained. For example, by including a larger amount of polymer relative to water, a more rigid hydrogel may be obtained. Alternately, by including a smaller amount of polymer relative to water, a more spongy hydrogel may be obtained. The rigidity or sponginess of the hydrogel may be selected depending on the desired end usage. A rigid hydrogel may not require a support chamber or the like and so may be used in situations where a support chamber is not desirable.

The scintillation composition may include additional components to initiate or catalyze polymerization of the polymer matrix material as known in the art, such as a crosslinking agent. By way of example only, if an acrylamide is used as the polymer matrix material, ammonium persulfate and N,N,N′,N′-tetramethylethylenediamine (TEMED) may be used to polymerize the acrylamide. The ratio of the polymer matrix material to the initiator or catalyst may be adjusted depending on the desired rigidity, strength, and stability of the resulting hydrogel. For example, the ratio of the acrylamide to the ammonium persulfate and TEMED may be adjusted depending on the desired rigidity, strength, and stability of the resulting hydrogel. If other materials are used as the polymer matrix material, the additional components to initiate or catalyze polymerization may be selected to produce the desired rigidity, strength, and stability of the resulting hydrogel.

By way of example only, the scintillation composition may include as an optional component a fluorophore for enhancement of light yield depending on the type of radiation to be detected. However, if the scintillation composition includes a scintillation component that provides a sufficiently high light yield, the scintillation composition may be substantially free of a fluorophore, which may reduce the cost of the scintillation composition while still providing enhancement of the light yield.

The scintillation composition may be produced by combining the components at ambient (room) temperature, such as from about 20° C. to about 25° C., and ambient pressure for an amount of time ranging from about 0.5 minute to about 30 minutes, such as from about 0.5 minute to about 5 minutes. Thus, the scintillation composition may be easily and quickly produced. The scintillation composition may be a homogeneous mixture since the components are either water soluble and remain water soluble or remain dispersed/suspended during the polymerization of the scintillation composition into the hydrogel. All of the components except for the polymer matrix material and initiators/catalysts may be combined with mixing, followed by the addition of the polymer matrix material and initiators/catalysts to initiate the polymerization of the scintillation composition. Once formulated, the scintillation composition may be poured into a mold and polymerized, producing the hydrogel. The mold, such as an acrylic mold, may exhibit a desired shape and size to produce the hydrogel to be used in a detector, such as a conventional detector. Exemplary shapes are depicted in FIG. 2, which shows that a variety of differently-shaped hydrogels may be produced. The shape of the mold may be configured to accommodate size or shape restrictions for the detector, which depends on the type of radiation to be detected. Following a sufficient amount of time for the polymer matrix material to polymerize, the scintillation composition may be solidified into the hydrogel, which may be removed from the mold.

The resulting hydrogel may be optically transparent and sufficiently rigid to maintain its shape after release from the mold. The hydrogel may also exhibit sufficient mechanical strength and stability to remain intact when dropped, e.g., from a distance of about three feet. Thus, the hydrogel may exhibit desirable properties of both crystalline and plastic materials. Depending on the polymer matrix material used, the scintillation composition may polymerize into the hydrogel in an amount of time ranging from about 0.5 minutes to about 60 minutes. The polymerization time may also vary depending on whether water or an organic solvent is present in the scintillation composition. However, the hydrogel may be easily and quickly produced from the scintillation composition. In contrast, conventional crystalline scintillation materials are grown and, therefore, longer amounts of time are needed for their production. Crystalline scintillation materials may also be more fragile than the hydrogels of the disclosure.

The hydrogel scintillator according to embodiments of the disclosure may be far less expensive and lighter than previous scintillators and may be easy to produce in large sizes over 1 liter. The scintillators according to embodiments of the disclosure may be a variety of shapes and colors. The wavelength of light may be tuned by selection of scintillator materials, such as core and shell materials. For example, the tuning of wavelengths of light may be done with cadmium selenide zinc sulfide (CdSe/ZnS) and cadmium telluride (CdTe) quantum dots. The hydrogel-based scintillation composition according to embodiments of the disclosure is also versatile and may incorporate one or a combination of scintillation components in a durable polymer matrix. The hydrogel may have a very high-quality light transmissibility, with expected high spectroscopic performance (10% at 662 keV). The hydrogels may easily be formed at a 4 L size for use in existing portal monitors with an added weight of perhaps 10% above the standard portal monitor, which is much less than the conventional crystal scintillators.

The hydrogels of the disclosure may be used to detect nuclear reactions and/or nuclear materials. For example, the hydrogels may be used in detectors (e.g., a neutron detector or a gamma ray detector) that detect radiation particles. The hydrogels of the disclosure may be used in many applications, including national and homeland security, industry, medical, and science. By way of example only, the hydrogels of the disclosure may be used to monitor known special nuclear material to ensure its security and ensure that the special nuclear material is fully accounted for, such as monitoring of vehicles and cargo containers at ports and border crossings (domestic and international) for the presence of radioactive material. Specific applications for the hydrogel may include, but are not limited to, medical imaging (e.g., single photon emission computed tomography (SPECT), positron emission tomography (PET), and computed tomography (CT)); health physics for neutrons and gamma dose monitors; security uses for the Transportation Security Administration (TSA), U.S. Coast Guard, Customs and Border Protection; High Energy Physics (HEP) for particle and photon imaging; geological survey for uranium and thorium via spectroscopy; mineral exploration; oil industry (density, spectroscopy); or space exploration. The hydrogels of the disclosure may also be used in fabrics to provide clothing that can sense the presence of radiation in a given environment. The gel-like nature of the hydrogels may provide a range of motion for use in clothing, enabling the wearer to move about freely. For example, the hydrogel may be used in military uniforms.

The hydrogel according to embodiments of the disclosure may also find use in a “pixelated” or “array” assembly that is used for imaging purposes. Manufacturing these types of arrays is labor intensive as each pixel needs to be cut, polished, and mounted to the array assembly. The hydrogels according to embodiments of the disclosure may be adapted to this technology by the insertion of reflective walls into the hydrogel prior to polymerization. By including a hydrogel in the array assembly, a 3-dimensional pixelated detector may be rapidly manufactured at low cost as opposed to the prohibitively high cost of creating these detector arrays by conventional techniques. In addition, the hydrogel may allow for non-traditional shapes and layers to be pursued, such as sinusoidal layers to minimize streaming paths, which will optimize array assemblies for each detection need.

The hydrogels of the disclosure may be a hybrid between a crystalline, liquid, and plastic scintillator material, incorporating desirable properties of conventional scintillators without incurring many of the disadvantages. The hydrogels may be formulated to exhibit properties of crystalline, liquid, and plastic scintillators, which may enable more efficient, stable, and safer operation of the detection systems for neutron and gamma ray detection. By way of example only, the hydrogels may be more robust and may have greater mechanical stability than conventional solid (e.g., crystalline or plastic) scintillator materials. The hydrogels may also exhibit the internal structure of a crystalline scintillator material and may not have dead voids, as is common with conventional plastic scintillator materials. The hydrogels may also retain the hydrogen properties of a conventional liquid scintillator material. Since the hydrogels are formed from a water soluble composition, the scintillation components may be homogenously dispersed in the hydrogels of the disclosure, unlike with conventional plastic scintillator materials. In addition, the hydrogels of the disclosure may be formed from non-hazardous or non-toxic components and, therefore, may be safer and more environmentally friendly to make than conventional plastic scintillator materials. The scintillation compositions that are used to produce the hydrogels of the disclosure may also be easily and quickly formed, reducing the production time and expense of the hydrogels.

The hydrogels of the disclosure may be one or more of mobile (e.g., transportable), compact, robust, and low-maintenance. In addition, the hydrogels may not be sensitive to background radiation, leading to high neutron/gamma discrimination for a neutrino detection scintillation composition. The hydrogels formed from the scintillation composition may have higher detection efficiencies than conventional liquid and plastic scintillators, which may provide decreased response time and quicker processing whether it is cargo scanning or nuclear reactor monitoring for SNM production.

In one aspect, the scintillation composition may be used for gamma ray detection and may be referred to herein as a gamma ray detection scintillation composition. The gamma ray detection scintillation composition may include one or a combination of quantum dots dispersed in a polymer matrix material. In particular, the gamma ray detection scintillation composition may include one or a combination of quantum dots as the scintillation component, and acrylamide as the polymer matrix material. In other aspects, the gamma ray detection scintillation composition may include one or a combination of cadmium selenide/zinc sulfide (CdSe/ZnS), cadmium telluride (CdTe) and cadmium zinc telluride (CdZnTe) quantum dots as the scintillation component, and acrylamide as the polymer matrix material.

The hydrogel may be produced from the gamma ray detection scintillation composition by polymerizing the polymer matrix material, wherein the scintillation components may be homogenously dispersed in the hydrogel. The gamma ray detection scintillation composition may be poured into a mold, such as an acrylic mold, having a desired shape and size. The shape of the mold may be configured to accommodate the size or shape restrictions for the type of conventional gamma ray detector system to be used. Following a sufficient amount of time for the acrylamide to polymerize, the gamma ray detection scintillation composition may be solidified into the hydrogel and removed from the mold. When acrylamide is used as the polymer matrix material, the gamma ray detection scintillation composition may readily polymerize into the hydrogel. Thus, the hydrogel may be easily and quickly produced from the gamma ray detection scintillation composition.

The hydrogel produced from the gamma ray detection scintillation composition may be advantageous compared to conventional gamma ray detection agents due to its ability to be one or more of compact, mobile, non-flammable, and environmentally friendly as well as having high light yield and resolution. A hydrogel produced from the gamma ray detection scintillation composition may incorporate the best properties of both liquid and solid type scintillators, without their disadvantages. Conventional gamma capture agents may use unstable compounds which may have to be constantly monitored and purified if liquid, may be highly fragile if in the crystal form, such as high purity germanium (HPGe) and sodium iodide (NaI), and may have lengthy processing and non-homogeneous materials causing “dead voids” in detection for plastics. The gamma ray detection scintillation composition according to embodiments of the disclosure may use the positive aspects of liquid scintillators and may avoid the stability problems of the solid polymers by retaining a semi-solid gel while also having the benefits of quantum dots such as CdTe, CdZnTe, and/or CdSe/ZnS nanoparticles.

In another aspect, the scintillation composition is used to detect neutrons and is referred to herein as a neutron detection scintillation composition. The neutron detection scintillation composition may include a neutron-capturing isotope and one type or more than one type of quantum dots dispersed in a polymer matrix material. The neutron detection scintillation composition may include the neutron-capturing isotope in the form of an organic or inorganic compound, quantum dots as the scintillation component, and the polymer matrix material. The neutron detection scintillation composition may include ⁶Li, in the form of LiCl, as the neutron-capturing isotope, quantum dots such CdTe, CdZnTe, and/or CdSe/ZnS nanoparticles as the scintillation component, and acrylamide as the polymer matrix material. The LiCl may be present in the neutron detection scintillation composition at a loading of ⁶Li in the range of from about 10% to about 40% by volume. The LiCl may be present in the neutron detection scintillation composition at a maximum loading of ⁶Li of about 40% by volume. For example, the LiCl may be present in the neutron detection scintillation composition at a maximum loading of ⁶Li of about 25% by volume. With its high ⁶Li loading and high neutron-capture cross section, the LiCl may enable the neutron detection scintillation composition according to embodiments of the disclosure to exhibit a larger neutron-capture cross section than conventional scintillators. By using ⁶Li, the neutron detection scintillation composition may be substantially free of a fluorophore dye for enhancement of light yield. Therefore, the cost of the neutron detection scintillation composition may be reduced while still providing enhancement of the light yield. However, the neutron detection scintillation composition may optionally include a fluorophore in combination with a non-fluorophore compound in order to maximize the light yield during neutron/gamma detection.

The hydrogel may be produced from the neutron detection scintillation composition by polymerizing the polymer matrix material. Once polymerized, the components of the neutron detection scintillation composition may be homogenously dispersed in the resulting hydrogel. A higher concentration of neutron-capturing isotope may be present in the hydrogel than may be present in conventional crystalline, liquid, or plastic scintillators due to the higher capture isotope loading in the neutron detection scintillation composition. The resulting hydrogel may not exhibit the disadvantages of conventional He-3 replacement technologies because the neutron detection scintillation composition takes advantage of the dispersion, capture isotope loading, and gelling properties of the polymer matrix material. The resulting hydrogel may be used in conventional He-3 neutron detector systems with minimal retrofit and may yield high resolution neutron detection because of the high light output. Using the hydrogel produced from the neutron detection scintillation composition may be expected to replace dwindling supplies of He-3 for use in compact neutron detectors, enabling the continuous, non-intrusive, unattended measurements suitable for the United States Department of National and Homeland Security deployment to spot neutron emissions, such as from shipping containers housing smuggled plutonium.

The neutron detection scintillation composition may be poured into a mold, such as an acrylic mold, having a desired shape and size. The shape of the mold may be configured to accommodate the size or shape restrictions for the type of conventional He-3 neutron detector system to be used. Following a sufficient amount of time for the polymer matrix to polymerize, the neutron detection scintillation composition may be solidified into the hydrogel and removed from the mold. When acrylamide is used as the polymer matrix material, the neutron detection scintillation composition may readily polymerize into the hydrogel. Thus, the hydrogel may be easily and quickly produced from the neutron detection scintillation composition.

In some aspects, the scintillation composition may be used to detect neutrons and gamma rays and is referred to herein as a neutron and gamma ray detection scintillation composition. The neutron and gamma ray detection scintillation composition may be composed of the polymer matrix material having a combination of two or more types of quantum dots and a neutron-capturing isotope dispersed therein. A hydrogel may be produced from the neutron and gamma ray detection scintillation composition by polymerizing the polymer matrix material. Once polymerized, the components of the neutron and gamma ray detection scintillation composition may be homogenously dispersed in the resulting hydrogel.

The hydrogels produced from the neutron detection scintillation composition, from the gamma ray detection scintillation composition, or from the neutron and gamma ray detection scintillation composition may be used in conventional detection systems, e.g., detectors, such as a conventional neutron detector or a conventional gamma ray detector. Such detectors include, but are not limited to, those described in U.S. Pat. No. 9,505,977 to Riddle et al., the entire disclosure of which is hereby incorporated by reference herein. Although designs of neutron detectors vary based on the way in which the conversion material is arranged and how the neutron absorption reaction products are detected, the neutron detectors may be classified into one of three main categories: proportional, scintillator, or semiconductor detectors. The hydrogels produced from the neutron detection scintillation composition may be used in any of these types of neutron detector. The proportional detectors use a gas to amplify the charge from the original charged particles generated by a neutron absorption reaction in the hydrogels of the disclosure. The amplified charge is proportional to the original charge. A ³He proportional detector uses ³He gas as both the conversion material and for the gas amplification. Other proportional detectors use a layer of the hydrogels of the disclosure, with argon gas that provides the charge amplification. These neutron detectors are sealed gas-filled tubes with electronic connections. During use and operation of the neutron detectors, the hydrogels of the disclosure emit light when struck by an incoming particle. When the hydrogels absorb neutrons, the resulting charged particles deposit energy. This causes the emission of light that may be converted to an electric signal, which is measurable. The semiconductor neutron detectors include semiconductor chips with the hydrogels of the disclosure. The hydrogels may be incorporated into the chip, applied in a layer on the chip, or applied to a three-dimensional structure on the chip. These semiconductor detector types are, respectively, referred to as bulk semiconductor, coated/layered semiconductor, and three-dimensional semiconductor detectors. The charged particles from a neutron absorption reaction in the hydrogels deposit energy in the semiconductor, creating a measurable electric signal.

The hydrogels produced from the neutron detection scintillation composition or from the gamma ray detection scintillation composition may be appropriately shaped and sized, e.g., by using an appropriately shaped and sized mold or by cutting, for the particular environment in which the detection function is carried out. Since the hydrogel may be sized and shaped as desired, the hydrogel may be used in a compact photomultiplier tubes (PMT) detector, such as a PMT detector having an active volume of about 1 m³ or less. In use, the resulting hydrogel, which may be tailored to have quantum dots of varying size, structure and/or composition, may fluoresce at a wavelength range from about 290 nm to about 485 nm, which is within the energy range for gamma excitation and PMT detection. The PMT detector may include an array of detectors and associated detector circuitry that is configured to feed into at least one processor. The processor includes programming that is configured to analyze received signal data. Thus, the processor is operable to provide output indicative of respective results of a material, including whether radioactive (or questionable) material has been detected.

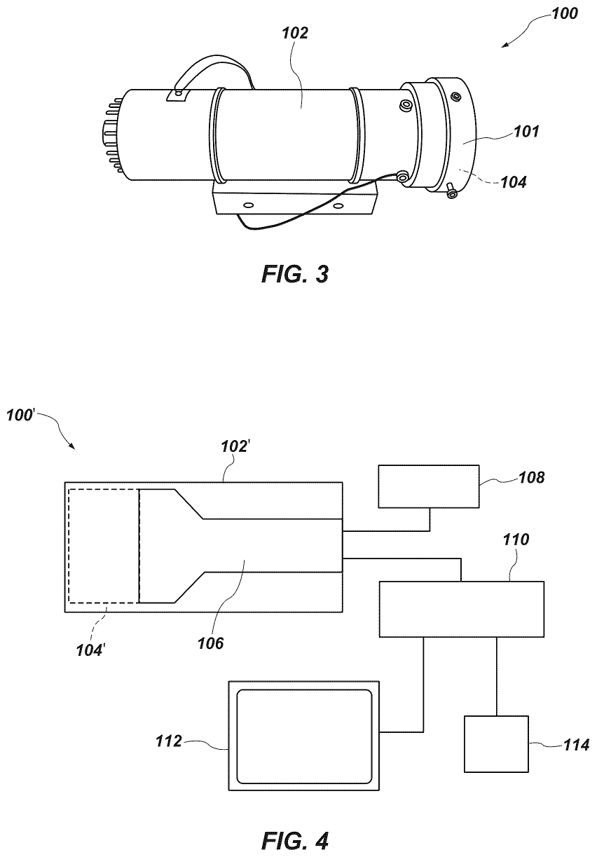

The hydrogel (not shown) may be placed in an enclosure 102 (e.g., a PMT housing) of a detector 100, as shown in FIG. 3, configured to detect neutrons or gamma rays. The hydrogel 104 may be one or more of the hydrogels as described above and is located in the enclosure 102. The hydrogel may be encased in a top portion 101 of the housing 102.

As shown in FIG. 4, a detector 100′ includes an enclosure 102′, the hydrogel 104′, at least one PMT tube 106, a voltage supply 108, circuitry 110, a readout device 112 (e.g., a display), and a data storage 114. The hydrogel 104 may be one or more of the hydrogels as described above and is located in the enclosure 102. FIG. 4 is a schematic representation of the detector 100′ and, for simplicity, not all detector components are shown. The circuitry 110 includes at least one processor. The processor may be associated with computer programming that includes computer executable instructions in the data storage 114 that is configured to identify and analyze the actuation intensity of the scintillation compound in the hydrogel. The circuitry 110 may also include (or be in operative connection with) other components, including any of a pulse discriminator, a digital counter, a multichannel analyzer, an amplifier, and/or a coincidence circuit. The circuitry 110 enables a determination to be made on whether nuclear (e.g., radioactive) material has been detected or is present.

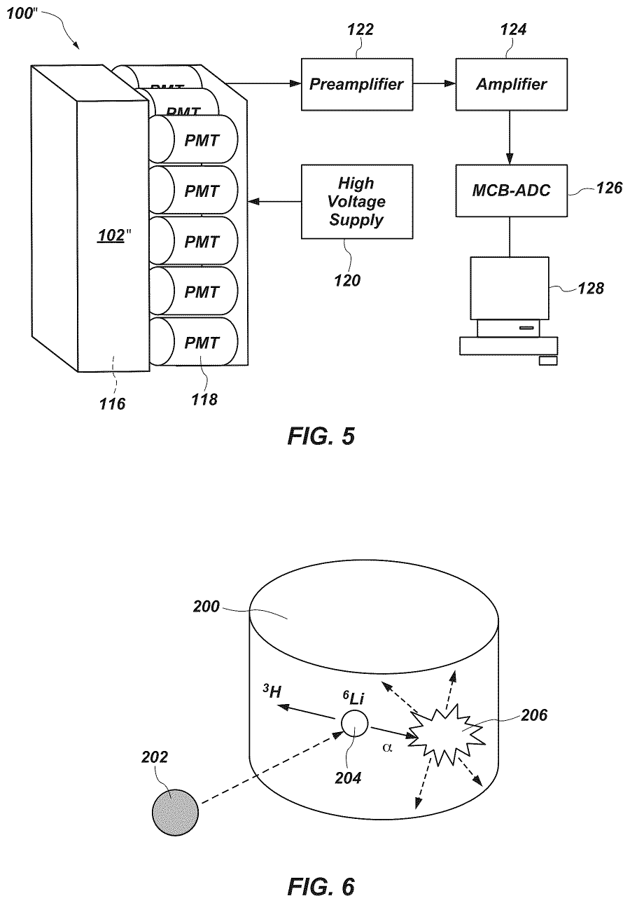

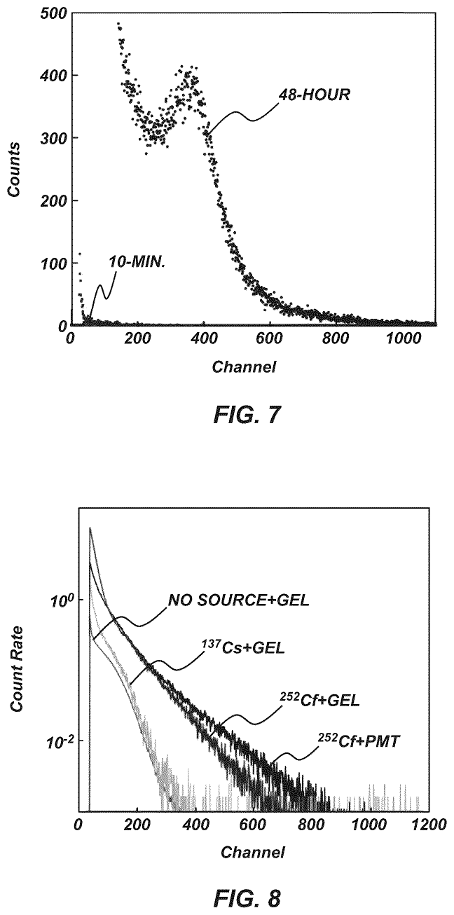

An alternative detector 100″ is shown in FIG. 5 and includes a hydrogel 116 in proximity to an array of PMT tubes 118, a preamplifier 122, an amplifier 124, and a computer 128. The detector 100″ also includes a power supply 120 (e.g., a high voltage power supply). The hydrogel 116 may be one or more of the hydrogels as described above and is located in an enclosure 102″. The PMT tubes 118 are supplied with high voltage power from the power supply 120. The PMT tubes 118 are each in operative connection with a base unit that incorporates a preamplifier 122. The preamplifier 122 integrates the charge impulse from an anode of the PMT tubes 118. Signals from the preamplifier 122 are delivered to the amplifier 124. The signals from the amplifiers 124 are converted to digitized signals using a multichannel buffer (MCB) and analog to digital converter (ADC) generally indicated 126. The digital output signals are delivered to the computer 128, which includes circuitry (not shown) including at least one processor and at least one data storage. The computer 128 operates to save the digitized outputs corresponding to the outputs from the PMT tubes 118. The digitized outputs are captured in the data storage of the computer 128 and analyzed using computer programs.

The hydrogel may be used to detect neutrons and/or gamma radiation emitted from an article that is believed to contain a nuclear material. The hydrogel may be used to detect nuclear reactions and/or nuclear materials. The hydrogel may be housed in the detector 100, 100′, 100″ as described above. The article to be tested may be positioned proximal to the detector 100, 100′, 100″ such that the hydrogel is able to detect any neutrons and/or gamma radiation emitted from the article. Upon exposure to neutrons and/or gamma radiation emitted from the article, the hydrogel may emit a particular wavelength of light, which is detected and quantified by the detector 100, 100′, 100″. The specific wavelength of light emitted by the hydrogel may depend on the gamma and neutron radiation being detected. A radiation signature of the light emitted by the hydrogel may be used to identify the nuclear material in the article. By tailoring the material composition and concentration of the quantum dots in the scintillation composition from which the hydrogel is formed, the hydrogel may be used to detect one or more radionuclides in the article.

The following examples serve to explain embodiments of the disclosure in more detail. These examples are not to be construed as being exhaustive or exclusive as to the scope of the disclosure.

### EXAMPLES

### Scintillation Hydrogel for Isotopic Neutron Emitters.

### Fabrication.

Five grams of enriched LiCl (e.g., enriched ⁶LiCl) were dissolved in 6 ml water and left overnight to dissolve completely. Once transparency (79% transmission at 450 nm wavelength) was achieved after 24 hours, 6 ml of bis-acrylamide monomer was poured into the solution, along with 0.5 mL of a 10% ammonium persulfate solution. Subsequently, 5 mg of water-soluble cadmium selenide capped with zinc sulfide (CdSe/ZnS) quantum dots were poured into the monomer solution, and 0.3 ml of TEMED was added to polymerize the solution into gel form. The scintillation hydrogel and a representation of how it functions is shown in FIG. 6. The scintillation hydrogel 200 includes quantum dots 204. Only one quantum dot 204 is shown for simplicity. Neutron radiation is converted to charged particles 202, one shown for simplicity, which excite the quantum dots 204 to release photons 206.

### Detection Principle.

The detection system for the scintillation hydrogel material uses lithium-6 (⁶Li) which has a large cross section for thermal neutron-capture. High loadings of ⁶Li may be achieved using enriched LiCl, which is highly soluble in water (84.25 g of LiCl may dissolve in 100 mL of water at 25° C.). Since the gel is water-based, ⁶LiCl maximizes ⁶Li content. The amount of ⁶LiCl and water was determined by optimizing the following three factors: maximizing ⁶Li weight %, minimizing water content, and maximizing optical transmission at 450 nm. The ⁶Li(n,α) reaction has a Q-value of 4.78 MeV and produces a 2.05 MeV alpha particle and a 2.73 MeV triton upon interacting with a thermal neutron. The light yield of the triton is about 5 times greater than that of the alpha particle, but both may excite water-soluble CdSe/ZnS quantum dots with carboxylic acid ligands to produce scintillation light peaking at 450 nm. When this scintillation light is collected by a photodetector, such as a PMT, information regarding the radiation event is obtained. The water content is minimized, because the water itself may perform as a separate detector, producing Cerenkov scintillation light. Pulse height discrimination may be used to minimize Cerenkov scintillation light (also termed Cerenkov noise). Alternatively, for purity and precision of data, pulse shape discrimination is possible with the detector, so that separate neutron counts are obtained from gamma-ray, muon, or Cerenkov counts.

### Performance Analysis.

During these tests, the hydrogel showed a 79% transmission ability at 450 nm, which was comparable to the transmission ability of NaI crystals (90%) and much better than the transmission ability of plastic scintillators (which show an average of 43%).

Before loading the hydrogel with LiCl or QDs, an “empty” gel was fabricated that was composed of mostly water and the polymerized monomer, and the additional catalyst. As shown in FIG. 8, a 48-hour and 10-minute measurement of the empty gel spectra without any sources present was performed. A noticeable “hump” is observed at approximately channel 400, but for only the 48-hour measurement. The hump was theorized to have originated from muons interacting with the water in the gel, and since muons are rare events, they were only noticeable on the longer 48-hour measurement.

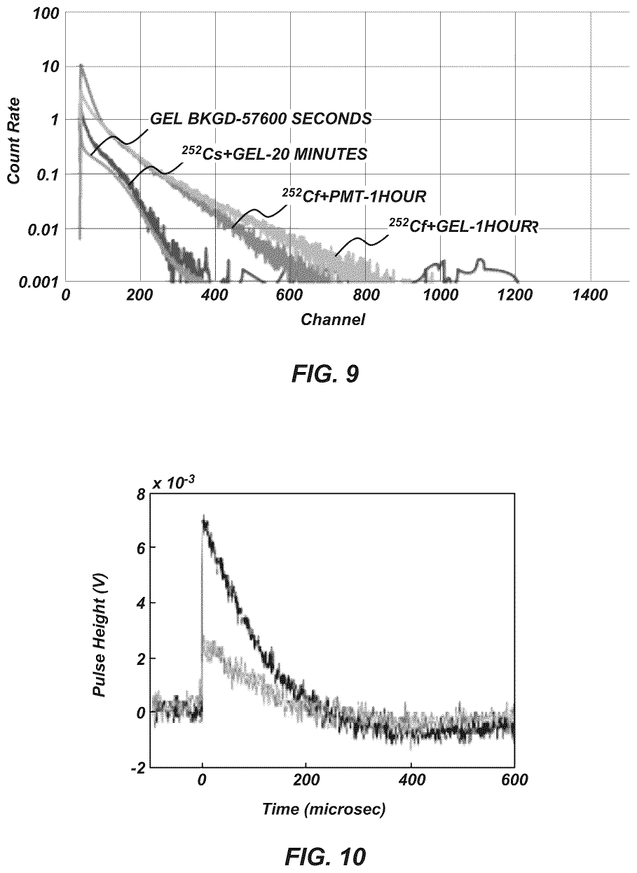

The ⁶LiCl+CdSe/ZnS gel was wrapped in TEFLON® and coupled to the PMT window using optical glue. A measurement was carried out without any source, and a noticeable bump was once again observed. Subsequently, a cesium-137 (¹³⁷Cs) source (whose activity matched the gamma-ray flux of the californium-252 (²⁵²Cf) source) was used to irradiate the gel. This was performed to determine the gamma-ray event contribution to the ²⁵²Cf spectra, and to set a lower limit of detection (LLD) to reduce background noise and gamma radiation. Before irradiating the gel with ²⁵²Cf, the PMT (without gel) was irradiated with ²⁵²Cf to determine the Cerenkov contribution that originated from gamma-rays and neutrons interacting with the PMT window. This contribution was quite significant (as shown in FIG. 9). Finally, upon irradiation of the gel with the ²¹²Cf, a higher count rate than the ²⁵²Cf+PMT measurement was observed above LLD 400 (determined by the ¹³⁷Cs+gel measurement). The count rates for each of the measurements are provided in Table 1. In all cases of using the ²¹²Cf, both a bismuth shield and polyethylene moderator were used, while for the ¹³⁷Cs, the same bismuth shield was used.

TABLE 1

| Measurement | Count Rate |
|---|---|
| No source + gel | 0.48 ± 0.003 |
| ¹³⁷Cs + gel | 0.52 ± 0.021 |
| ²⁵²Cf + PMT | 1.74 ± 0.022 |
| ²⁵²Cf + gel | 3.66 ± 0.031 |

Between channels 0 and 100, the count rate for the ²⁵²Cf+PMT was higher than that of the ²⁵²Cf+gel (see FIG. 9). This was believed to be due to the gel acting as a shield for the neutrons and gamma rays, slowing down their speed and reducing their energies. Above LLD 400, the count rate for the ²⁵²Cf+gel was higher than that of the ²⁵²Cf+PMT, indicating additional scintillation events over Cerenkov scintillation events shown in FIG. 10. To verify the two separate events, an oscilloscope was used to record the waveforms exiting the PMT directly before undergoing amplification and pulse shaping.

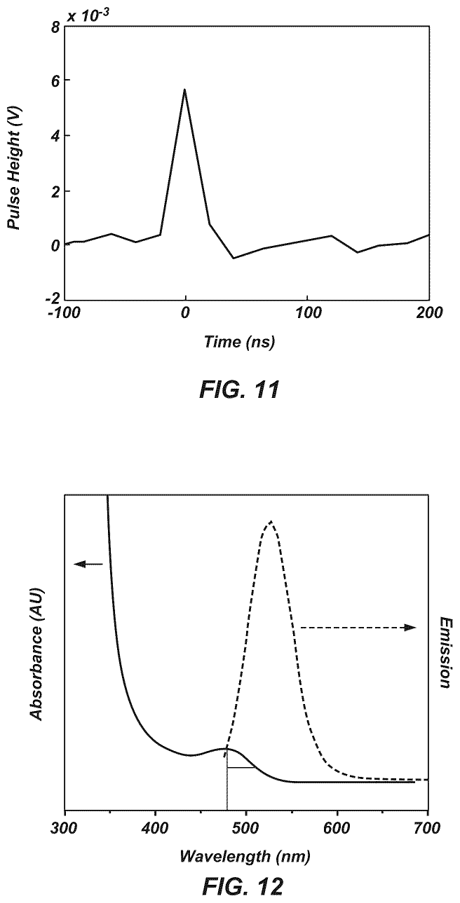

Waveforms upon irradiating the gel with ²⁵²Cf had three exponential decay times, the shortest being 23.5 μs, and the longest being 512 μs (FIG. 11). Waveforms upon irradiating the PMT with ²⁵²Cf had only one exponential decay time of 20 ns (FIG. 12). The waveforms with the hydrogel irradiation had much longer decay times than the PMT irradiation, validating the separate events in both the cases. The results indicate a need for performing pulse shape discrimination for distinguishing between the two events.

### Scintillation Hydrogel for Gamma Ray Detection.

The incorporation of quantum dots (cadmium selenide/zinc sulfide (CdSe/ZnS)) in the hydrogel matrix was useful for neutron detection. To expand the detection capabilities, the hydrogel matrix was modified to incorporate nanoparticles of cadmium telluride (CdTe), or cadmium zinc telluride (CdZnTe). The CdTe/CdZnTe compounds have a high gamma counting efficiency with a lower neutron sensitivity and are similar to semiconductor energy resolution.

A hydrogel of bis-acrylamide monomer was prepared, nanoparticles were added (CdSe/ZnS or CdZnTe) and the hydrogel was polymerized into gel form by the addition of TEMED. Table 2 provides a list of the components and their respective amounts in the formulations.

TABLE 2

| | Mass/Vol. per L | |
|---|---|---|
| Hydrogel Components | | |
| TEMED | 10-15 | mL |
| Acrylamide gel solution | 400-500 | mL |
| Ammonium persulfate (10% in H₂O) | 2-4 | mL |
| LiCl (water soluble) | 750-850 g @ | |
| | 25° C. | |
| Deionized Water | 400-500 | mL |
| Nanoparticle Components | | |
| Zinc Chloride (nano starter) | 30-60 | g |
| Sodium Sulfide (nano starter) | 18-30 | g |
| 3-Mercaptopropionic Acid (nano starter) | 10-100 | mL |
| Tetrapropylammonium hydroxide (nano starter) | 10-100 | mL |
| Cadmium Telluride (nano starter) | 2-10 | g |
| Cadmium Selenide Zinc Sulfide (nano starter) | 3-10 | g |
| Indium Phosphate/Zinc Sulfide (InP/ZnS) | 20-200 | g |

The scintillation hydrogel for gamma detection had a similar appearance and clarity of light transmission as the neutron detection hydrogel. The scintillators of this scintillation hydrogel were able to convert high energy gamma-rays to a near visible or visible light. In particular, the CdTe and CdZnTe nanoparticles had a high gamma counting efficiency with a lower neutron sensitivity. This scintillation material converted radiation into light pulses which may then be quantified to determine the energy and quantity of the radiation. The scintillation material was in close contact with a photomultiplier tube to convert the tiny quantity of photons into electrical pulses via a “cascade” type effect. In this way, a small signal, the photons of light produced by the interaction of a radiation event and the scintillation material, was detected, and quantified by the electronics assigned to the detector.

### Scintillation Hydrogel Comprising Indium-Phosphide Core/Zinc-Sulfide Shell Quantum Dots.

A hydrogel of bis-acrylamide monomer was prepared, nanoparticles were added (InP/ZnS) and the hydrogel was polymerized into gel form by the addition of TEMED. Table 3 provides a list of the components and their respective amounts in the formulations.

TABLE 3

| | Mass/Vol. per L | |
|---|---|---|
| Hydrogel Components | | |
| TEMED | 10-15 | mL |
| Acrylamide gel solution | 500 | mL |
| Ammonium persulfate (10% in H₂O) | 2-4 | mL |
| LiCl (water soluble) | 750-850 g @ | |
| | 25° C. | |
| Deionized Water | 500 | mL |
| Nanoparticle Components | | |
| Zinc Chloride (nano starter) | 40 | g |
| Sodium Sulfide (nano starter) | 18 | g |
| 3-Mercaptopropionic Acid (nano starter) | 10 | mL |
| Tetrapropylammonium hydroxide (nano starter) | 10 | mL |
| Indium Phosphide (nano starter) | 2 | g |
| Indium Phosphate/Zinc Sulfide (InP/ZnS) | 20-200 | g |

InP/ZnS quantum dots were tested since they are environmentally friendly and have a large stokes shift which prevents self-absorption of light. Light yield in the InP/ZnS quantum dots may also be improved due to the semiconductor core of InP that is passivated by a shell of the wider band gap found in the ZnS. The InP/ZnS showed good water solubility and, along with ⁶LiCl, enabled a high loading and a good gamma ray detection response as shown in FIG. 13.

While the disclosure may be susceptible to various modifications and alternative forms, specific embodiments have been shown by way of example in the Examples and drawings and have been described in detail herein. However, it should be understood that the disclosure is not intended to be limited to the particular forms disclosed. Rather, the disclosure is to cover all modifications, equivalents, and alternatives falling within the scope of the disclosure as defined by the following appended claims and their legal equivalents.

What is claimed is:

1. A scintillation composition comprising one or more different types of quantum dots dispersed in a polymer matrix material, the quantum dots comprising a core-shell structure.

2. The scintillation composition of claim 1, wherein the one or more different types of quantum dots comprise a narrow band gap semiconductor material and a wide band gap semiconductor material.

3. The scintillation composition of claim 1, wherein the one or more different types of quantum dots comprise CuF, CuCl, CuBr, CuI, AgF, AgCl, AgBr, AgI, CdO, CdSe, CdS, CdTe, CdZnTe, HgO, HgS, HgSe, HgTe, BeO, BeS, BeSe, BeTe, MgO, MgS, MgSe, MgTe, CdSeTe, ZnO, ZnSe, ZnTe, ZnS, ZnCdSe, ZnCdS, InAs, InP, InN, GaN, InSb, InAsP, InGaAs, GaAs, GaP, GaSb, AIP, AlN, AIAs, AlSb, BP, BaS, BSb, PbSe, PbTe, PbS, PbSnTe, Tl₂SnTe₅, GeS, GeSe, SnS, SnSe, GeTe, SnTe, PbO, CuInS, CuInSe, CuInTe, AgInS, AgInSe, AgInTe, SbSI, SbSBr, SbSeI, SbSeBr, SbTeI, BiSCl, BiSBr, BiSeCl, BiSeBr, BiSeI, CuInGaS, CuInGaSe, CuInGaTe, CuInS₂, CuInSe₂, CuInTe₂, CuGaS₂, CuGaSe₂, CuAlSe₂, CuGaTe₂, CuAlTe₂, AgInGaS, AgInGaSe, AgInGaTe, AgInS₂, AgInSe₂, AgInTe₂, AgGaS₂, AgGaSe₂, AgAlSe₂, AgGaTe₂, AgAlTe₂, or combinations thereof.

4. The scintillation composition of claim 1, wherein the one or more different types of quantum dots comprise a core comprising one or more of Cd, Se, In, and P, and a shell comprising one or more of Zn and S.

5. The scintillation composition of claim 1, wherein the polymer matrix material comprises acrylamide, bis-acrylamide, N,N-methylene bisacrylamide, poly(N-vinylcarbazole), silicone, non-plasticizing silicone gel, two-part components of a polyurethane, or combinations thereof.

6. The scintillation composition of claim 1, further comprising a neutron-capturing isotope.

7. The scintillation composition of claim 1, further comprising one or more of thallium doped cesium iodide, thallium doped sodium iodide, and cerium doped lutetium iodide.

8. A hydrogel comprising a polymerized matrix material and one or more different types of quantum dots in the polymer matrix material.

9. The hydrogel of claim 8, wherein the one or more different types of quantum dots comprise CuF, CuCl, CuBr, CuI, AgF, AgCl, AgBr, AgI, CdO, CdSe, CdS, CdTe, CdZnTe, HgO, HgS, HgSe, HgTe, BeO, BeS, BeSe, BeTe, MgO, MgS, MgSe, MgTe, CdSeTe, ZnO, ZnSe, ZnTe, ZnS, ZnCdSe, ZnCdS, InAs, InP, InN, GaN, InSb, InAsP, InGaAs, GaAs, GaP, GaSb, AIP, AlN, AIAs, AlSb, BP, BaS, BSb, PbSe, PbTe, PbS, PbSnTe, Tl₂SnTe₅, GeS, GeSe, SnS, SnSe, GeTe, SnTe, PbO, CuInS, CuInSe, CuInTe, AgInS, AgInSe, AgInTe, SbSI, SbSBr, SbSeI, SbSeBr, SbTeI, BiSCl, BiSBr, BiSeCl, BiSeBr, BiSeI, CuInGaS, CuInGaSe, CuInGaTe, CuInS₂, CuInSe₂, CuInTe₂, CuGaS₂, CuGaSe₂, CuAlSe₂, CuGaTe₂, CuAlTe₂, AgInGaS, AgInGaSe, AgInGaTe, AgInS₂, AgInSe₂, AgInTe₂, AgGaS₂, AgGaSe₂, AgAlSe₂, AgGaTe₂, AgAlTe₂, or combinations thereof.

10. The hydrogel of claim 8, wherein the one or more different types of quantum dots comprise a core-shell structure.

11. The hydrogel of claim 10, wherein the one or more different types of quantum dots comprise a core comprising one or more of Cd, Se, In, and P, and a shell comprising one or more of Zn and S.

12. The hydrogel of claim 8, further comprising a neutron-capturing isotope.

13. The hydrogel of claim 12, wherein the neutron-capturing isotope is ⁶Li, ¹⁰B, ¹¹³Cd, or ¹⁵⁷Gd.

14. The hydrogel of claim 8, wherein the polymerized matrix material comprises acrylamide, bis-acrylamide, N,N-methylene bisacrylamide, poly(N-vinylcarbazole), silicone, non-plasticizing silicone gel, two-part components of a polyurethane, or combinations thereof; and the polymer matrix material is polymerized with ammonium persulfate, N,N,N′,N′-tetramethylethylenediamine (TEMED), or a combination thereof.

15. The hydrogel of claim 8, wherein the hydrogel is rigid and substantially maintains its shape.

16. A detection system comprising:
an enclosure, at least one photomultiplier tube in the enclosure, and a hydrogel in proximity to the at least one photomultiplier tube, the hydrogel of the detection system configured to detect at least one of neutron radiation and gamma radiation, and the hydrogel comprising:
one or more different types of quantum dots and a polymerized matrix material.

17. The detection system of claim 16, wherein the detection system has an active volume of about 1 m³ or less.

18. The detection system of claim 16, wherein the hydrogel further comprises a neutron-capturing isotope.

19. A method of detecting radiation emitting from an article, comprising:
positioning an article emitting one or more of neutron radiation and gamma radiation proximal to a hydrogel in a detection system, the hydrogel comprising a polymerized matrix material comprising one or more different types of quantum dots and an optional neutron-capturing isotope; and
detecting the one or more of the neutron radiation and gamma radiation.

20. The method of claim 19, wherein positioning an article emitting one or more of neutron radiation and gamma radiation proximal to a hydrogel comprises positioning the article proximal to the hydrogel comprising quantum dots having a core-shell structure, wherein the core comprises one or more of Cd, Se, In, and P, and the shell comprises one or more of Zn and S.
